(19) United States
(12) Patent Application Publication
(10) Pub. No.: US 2015/0201800 A1
(43) Pub. Date: Jul. 23, 2015

(54) COOKING DEVICE AND METHOD WITH TEMPERATURE CONTROL

(71) Applicants: JASON RYU, TUSTIN, CA (US); IN-CHUL MOON, KIMPO-CITY (KR)

(72) Inventors: JASON RYU, TUSTIN, CA (US); IN-CHUL MOON, KIMPO-CITY (KR)

(21) Appl. No.: 14/598,487

(22) Filed: Jan. 16, 2015

Related U.S. Application Data
(63) Continuation-in-part of application No. 61/928,863, filed on Jan. 17, 2014.

(51) Int. Cl. A47J 36/04

(52) U.S. Cl. CPC A47J 36/04

(57) ABSTRACT

Cookware is provided having a multi-layer base including a heat contacting layer having a bottom surface for contacting a heat source, and an upper cooking layer having an upper surface for cooking food. The heat contacting layer's periphery engages the upper cooking layer's periphery with said heat contacting layer's upper surface spaced apart from the upper cooking layer's lower surface to form a central cavity. The cookware includes a heat transfer member located within this cavity. The heat transfer member includes a housing forming a ring shaped interior chamber. Infrared emitting stone granules, such as in powder form, is dispersed throughout the chamber to form a ring shaped region which emits infrared rays, and preferably far infrared rays, when heated.

### RELATED APPLICATIONS

The present application is a continuation-in-part of co-pending U.S. patent application Ser. No. 61/928,863 filed on Jan. 17, 2014.

### BACKGROUND OF INVENTION

The present invention relates to cooking devices and methods with improved temperature control. In particular, it relates to cookware that limits the temperature of the cooking surface of the cookware by providing an air channel to allow heated air to circulate between layers of conductive material in the base of the cookware and an air ventilating hole to allow excessive hot air to escape. The cookware may also have a plurality of layers of conductive material such as metal interspersed with one or more layers of mineral such as jade or other heat-radiating materials.

Conventional cookware is generally composed of a container having vertical sidewalls extending upwardly from a bottom wall, one or more handles, and, optionally, a lid. At least the bottom wall is made of a heat conductive material such as metal to transfer heat from the lower surface of the bottom wall from a heat source such as a stovetop burner to food placed on the top surface. High-quality cookware in which heat is transferred uniformly throughout the conductive heat cooking surface, for example, iron, aluminum and copper cookware, are also well known for cooking. Such cookware often includes a non-stick coating on the top surface of the metal cooking surface to prevent food or food residue from adhering to the surface.

Many foods, such as eggs and vegetables are boiled because boiling maintains the maximum temperature of the food at the boiling point of the liquid used, such as water at 100° C., to provide even cooking and prevent overcooking It is often desirable, however, to cook foods with little or no water to avoid loss of nutrients in the food being cooked. It is also desirable to cook food with little or no cooking oil to reduce fat consumption. No current designs of cookware allow the maintenance of the temperature of the cookware over time without overheating without the presence of a liquid such as water or oil. Overheating can lead not only to the loss of nutrients in the food being cooked, but damage to the non-stick coating or even the cookware itself. No current designs allow for cooking without liquid repeatedly, while maintaining any non-stick qualities on the cooking surface.

Foods may also be fried in hot oil such as vegetable oil. The boiling point of vegetable oil is about 150° C., and restaurants usually fry food in oil at temperatures between 150° C. and 180° C. If the temperature of the oil is too hot, toxins such as acrolein may be introduced.

Unless otherwise equipped, all cookware and bakeware are strictly passive heat transferring utensils which have to solely depend on outside heating source having no capability what-so-ever to control the heat received from the heating source.

### BRIEF SUMMARY OF THE INVENTION

The invention is generally directed to devices and methods for heating materials or cooking food at a controlled temperature. The cookware allows the heating of its contents over a long period of time while maintaining the temperature within the desired temperature range.

The cookware preferably includes a plurality of layers of conductive material such as metal interspersed with one or more layers of a mineral such as jade or other heat-radiating materials, with such structure advantageously permitting heating or cooking food at a controlled temperature, even without the presence of water or other liquid, over a long period of time while maintaining the temperature within the desired range.

Some embodiments of the cookware include a multi-layer base including a heat contacting layer having a bottom surface for contacting a heat source, and an upper cooking layer having an upper surface for cooking food. The heat contacting layer's periphery engages the upper cooking layer's periphery with said heat contacting layer's upper surface spaced apart from the upper cooking layer's lower surface to form a central cavity. The cookware includes a heat transfer member located within this cavity. The heat transfer member having upper and bottom walls forms a housing with an interior chamber which is preferably ring shaped. The heat transfer member further has an infrared emitting stone powder or granules dispersed throughout the chamber to form a ring shaped region which emits infrared rays, and preferably far infrared rays, when heated.

Advantageously, the cookware provides improved temperature control in which the temperature of the cooking surface of the cookware provides for more uniform heat distribution to the cooking surface.

### BRIEF DESCRIPTION OF THE DRAWINGS

Other advantages of the present invention will be readily appreciated as the same becomes better understood by reference to the following detailed description when considered in connection with the accompanying drawings:

FIG. 1 is an exploded view showing the layers of an embodiment of this invention;

FIG. 2 is an additional exploded view showing the layers of an embodiment of this invention; and

FIG. 3 is a side cut-away view of the cookware shown in FIG. 2.

### DETAILED DESCRIPTION OF THE INVENTION

With reference to the drawings and in operation, embodiments of the invention overcome some of the disadvantages of existing cookware by providing apparatus, systems and methods for maintaining temperature within a desired temperature range, among other things.

The cookware may be constructed in a variety of different forms such as saucepans, frying pans, multi-purpose pots and pans, roasting pans, etc. The cookware may be used for cooking food with little or no added liquid (water or oil, for example), or may be used to control the temperature of the cooking liquid when boiling food in water or frying it in oil.

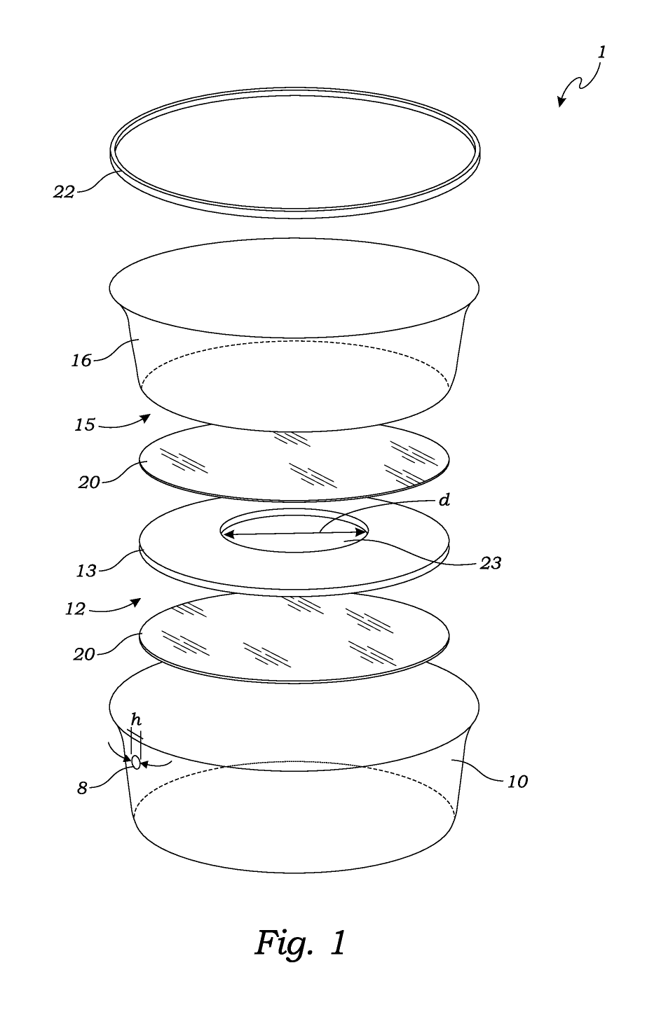

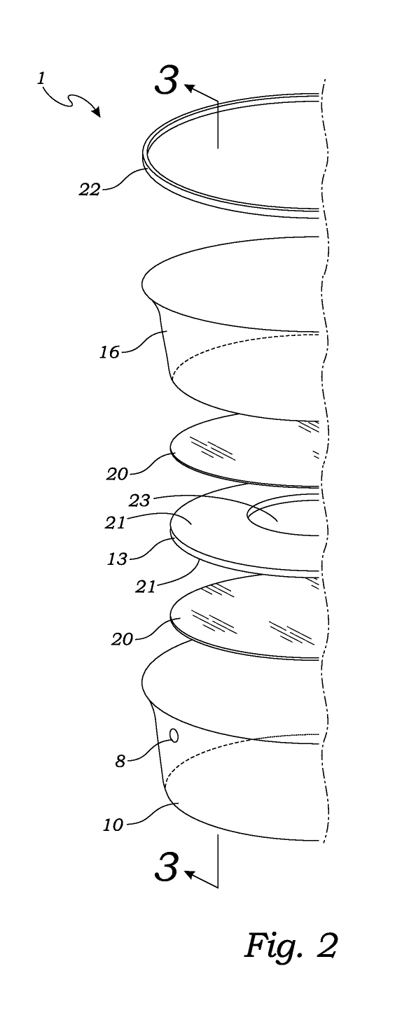

In a first embodiment, the cookware 1 is a pan (see FIGS. 1-3) for use on a suitable heat source, such as a stove or grill. However, the pan can be in any suitable shape, such as a sauce, multi-purpose or roasting pan. In addition, the pot or pan may be adapted for use on any heat source including a conventional gas or electric range or on other types of cooktops.

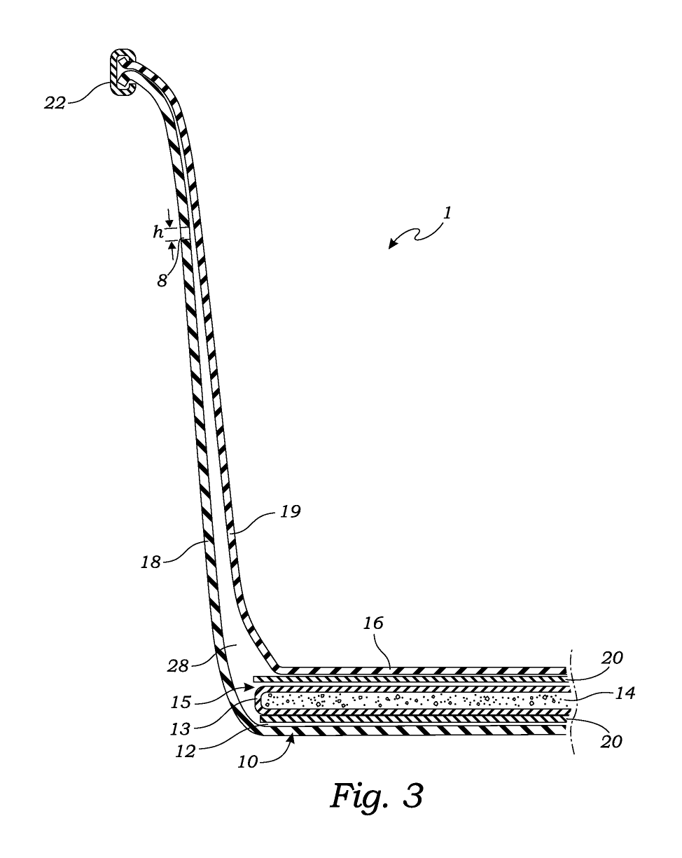

As shown in FIGS. 1-3, the cookware 1 of the invention has a multilayer structure in order to facilitate heat transfer and control. As best seen in the schematic view of FIG. 1, the cookware 1 includes a first heat conductive layer which forms the bottom of the cookware for being placed on a range top. As illustrated in FIG. 3, the first layer includes a bottom surface for engaging a heat source, and preferably includes an upwardly extending sidewall 18. The heat contacting conductor 10 can be constructed of any material suitable for engaging a heat source though metals such as aluminum, copper, stainless steel, etc. are preferred.

The cookware 1 also includes an upper thermal conducting layer 16 which forms the cooking surface for cooking food. Again, this conductor layer 16 preferably includes an upwardly extending sidewall 19 and can be constructed of any material suitable for cooking though metals such as aluminum, copper, stainless steel, etc. are preferred. The peripheries of the heat contacting layer 10 and cooking layer 16 engage to form generally traditional cooking structures such as pans and pots. Preferably, the peripheries of the heat contacting layer 10 and cooking layer 16 are locked together with a circular rim 22. Of importance, the heat contacting layer 10 and cooking layer 16 are spaced apart to form a central cavity 28 between heat contacting layer 10 and cooking layer 16 (as seen in FIG. 3).

The cookware 1 includes a heat transfer member 13 within the cavity 28. The cookware of the present invention includes numerous embodiments for the heat transfer member 13. In a first non-preferred embodiment, the heat transfer member 13 is a substantially solid single piece structure made of a material that emits infrared energy when heated. A suitable material for emitting infrared energy upon application of heat is jade stone. However, other materials may be employed. This embodiment of the heat transfer member may be made in various shapes and sizes.

In preferred embodiments as illustrated in FIGS. 1-3, the heat transfer member 13 includes a hollow housing 21 having upper and bottom walls forming an interior chamber. Preferably, the heat transfer member's hollow housing 21 is made of metal such as aluminum, copper, stainless steel, etc. Furthermore, in preferred embodiments, the cookware includes a solid or granular material 14 within the chamber that emits infrared energy when heated. A preferred infrared emitting material 14 is granular jade which may be in the form of jade powder. Jade is considered a preferred material because it has been found to be an efficient radiator of infrared rays and is cost effective. However, other infrared emitting materials may be employed.

The heat transfer member 13 may be positioned within the cookware's central cavity 28 so as to be spaced away from the heat contacting layer 10 and cooking layer 15 to create layers of air 12 and 15 between the heat transfer member 16 and heat contacting layer 10 and cooking layer 15. More specifically, preferably but not necessarily, the cookware includes a first layer of air 12 above the heat contact layer 10. Moreover, a second layer of air 15 is preferably provided above the heat transfer member 13 and below the cooking layer 16, whose upper surface forms the cooking surface of the cookware. The first layer of air 12 and the second layer of air 15 are preferably connected by a channel or passage, such as the annular space beyond the periphery of the heat transfer member 13, to allow air to flow between the layers of air 12, and 15. More layers of the heat transfer member 13 and infrared emitting materials may be incorporated as desired. In addition, the heat conducting layers 10, 13, and 16 may be flat or may be contoured or have undulations as shown in FIG. 1. A non-stick coating such as Teflon® is preferably provided on the cooking surface.

Furthermore, as illustrated in FIGS. 1-3, the cookware 1 may include discs 20 within the cavity 28 positioned above and/or below the heat transfer member 28. The discs enhance the even distribution of heat from the heat transfer member 13 to the cooking layer 15. The discs are preferably made of aluminum, copper or steel.

Preferably, the cookware of the present invention includes at least one air ventilating hole 8 which allows the escape of heated air from the air layers 12, and 15 between the conductor layers to the outside environment. In the embodiment shown in the FIGS. 1-3, air ventilating hole 8 is located toward the upper edge of the first heat contacting layer's sidewall 18. However, air ventilating hole 8 may be placed at any suitable location, such as for example the side of the pan, the handle, or the base. One or more air ventilating holes may be provided.

In operation, the presence of an air layer connecting channel 17 allows air to circulate through the upper and lower air layers 12, and 15 between the thermally conductive layers of the pan. As the air temperature between the thermally conductive layers increases, so does the air pressure in the air layers. The air ventilating hole 8 allows the excess heated air to escape.

The cookware may have one or more conventional fixed handles (not shown). The handle may be fixed or easily detachable by the user for convenient storage of the cookware in less space. Moreover, for aesthetics, the handle is preferably positioned to cover the vent hole 8, but still freely allows air to escape through the vent hole 8 to the ambient environment.

In some embodiments, such as that shown in FIGS. 1-3, the invention is directed to a cookware which advantageously provides for controlling heat used for cooking, by, among other things, limiting the cooking temperature at a certain “preset” maximum temperature range regardless to the time lapsed. Features of this embodiment are illustrated in FIGS. 1-3 and are described below:

Temperature Control Methods

Temperature control in the context of this embodiment of the invention differs than active controls, such as mechanisms that include a sensor and/or switch electrical device. Rather, this embodiment of the invention provides structural features which provide passive control of the temperature. These structural features include:

1) Double-Shell construction with air filled cavity between: With thermal conductivity of air being only about 0.01% of aluminum (at 25° C./77° F., aluminum: 205, air: 0.024), the air cavity works at least in part as the thermal insulation.

2) Air Release Hole: As the cavity's air temperature rises by heating, so does the volume of the air causing air to flow out through vent hole 8, and the rate of escaping air flow will also increase as the temperature rises. However, because the vent hole 8 size “h” is small compared to the total cavity volume, the temperature inside the cavity (and the air volume increase) will rise much faster than temperature loss from the escaping air flow, thus resulting in air pressure rising as well. Ultimately, the air pressure elevates high enough so that the flow rate or “burst” of escaping air through hole 8 will match the rate at which the air volume is increasing, while the rate of temperature rises slow as the temperature is pushed higher, eventually reaching the temperature point “X” at which two rates match each other, i.e., the air pressure rise due to continued heating will be in equilibrium with the air pressure drop due to escaping of pressurized air through hole 8 resulting in equilibrium between temperature rise by continued heating and the temperature loss due to heat loss (pressure loss) through vent hole 8, whereby cooking temperature of the inside cooking surface will stay at “X” despite continued heating, thus setting the maximum cooking surface temperature at “X”.

3) Temperature Controller Bundle: Contained in the bottom cavity of the cookware is a set of one or more heat transfer members 13. Each heat transfer member is preferably circular and may include a center hole for temperature controls. Preferably, the heat transfer member has a center hole with each transfer member being hollow forming a ring shaped chamber. The ring shaped chamber is filled with jade granules preferably having an about 1 mm diameter size which is for, among other things: i) insulation of fast heat transfer from heat source underneath to the inside bottom surface, thereby helping the initial temperature rise of the inside cooking surface to be as even as possible throughout the entire inside surface, both bottom and sidewall, by even heat transfer throughout the entire cavity air; ii) preservation of heat to be released after stop of heating; and iii) release of infrared radiation that assists in cooking of food. Jade granules can be substituted with other minerals, particularly minerals known to release far infrared radiation.

The heat transfer member is constructed with a center hole of varying size “d” to form the doughnut or disc shape. Furthermore, the cookware may include one or two sheet-metal discs 20 (aluminum, copper or steel). In still additional embodiments, instead of a central “doughnut” hole, the heat transfer member may include a plurality of holes which may be the same size or different sizes. The holes are positioned throughout the disc shaped heat transfer member, either in a pattern or randomly, which provide more efficient heat transfer and even heat distribution throughout the inside cooking surface, among other things.

The time required for initial heat-up of the cookware, particularly in the case of a frying or sauté pan, can be adjusted by the size of the central doughnut hole or size and number of the plurality of holes in the disc.

Given a set of structural parameters such as material, shape and size, the cooking surface temperature limit “X” of a particular cookware can be preset to an extent by adjusting the size “h” of Air Release Hole 8, as increase of “h” will cause drop of “X” though within a temperature range of about 350°˜470° F. while keeping “h” at a practical level.

The cookware and other embodiments of the invention discussed herein provide various cooking benefits, some of which may depend on how the variables are adjusted in its design. For example, some benefits may include:

1) Burn-free cooking even without water or oil (subject to following instructions) which is particularly good for cooking sauce or saucy food even without frequent stirring.

2) The cookware can be made specifically for Tempura making (frying) by setting “X” at about 350°˜470° F. which is known for ideal temperature for frying in many edible oils.

3) The cookware can be made specifically to simulate oven cooking but on a stove-top for baking and roasting of all types. Preferably, its lid also is made with a double-wall and an air cavity. It can also be equipped with an adjustable air release vent through the inside so as to widen the cooking temperature range. One good example is a stove-top pizza and cookie pan that can simulate a true pizza oven. Especially with adequate application of clay material inside the cavity, simulation of clay-pizza-oven is possible including release of far-infrared radiation cooking which is said to improve the taste of pizza due to the nature of far-infrared ray cooking/baking from within the dough.

Exemplary embodiments of these systems and methods are described above in detail. The systems and methods are not limited to the specific embodiments described herein, but rather, components of the systems and/or steps of the methods may be utilized independently and separately from other components and/or steps described herein. For example, the systems may also be used in combination with other systems and methods, and is not limited to practice with only the system and method as described herein. In addition, other materials, configurations and various sizes, than those shown or described herein may be employed and remain within the scope of the invention.

This written description uses examples to disclose the invention, including the best mode, and also to enable any person skilled in the art to practice the invention, including making and using any devices or systems and performing any incorporated methods. The invention may be practiced otherwise than as specifically described within the scope of this description.

While several particular forms of the invention have been illustrated and described, it will be apparent that various modifications can be made without departing from the spirit and scope of the invention. Therefore, it is not intended that the invention be limited except by the following claims. Having described my invention in such terms as to enable a person skilled in the art to understand the invention, recreate the invention and practice it, and having presently identified the presently preferred embodiments thereof, we claim:

1. A stovetop cookware comprising:
a heat contacting layer having a bottom surface for contacting a heat source, an upper interior surface, and a periphery;
an upper cooking layer having an upper surface for cooking food, a lower interior surface, and a periphery;
said heat contacting layer's periphery engaging said upper cooking layer's periphery with said heat contacting layer's upper surface spaced apart from said upper cooking layer's lower surface to form a central cavity; and
a heat transfer member within said cavity, said heat transfer member having upper and bottom walls forming a housing with a ring shaped interior chamber, said heat transfer member further having a granular stone dispersed throughout said ring shaped chamber.

2. The stovetop cookware of claim 1 wherein said heat contacting layer and upper cooking layer are round.

3. The stovetop cookware of claim 1 further comprising an air ventilating hole formed through heat contacting layer or said upper cooking layer to allow air to pass from within said cavity to the exterior environment.

4. The stovetop cookware of claim 1 wherein said granular stone is jade.

5. The stovetop cookware of claim 1 wherein said granular stone emitted infrared rays when heated.

6. The stovetop cookware of claim 1 wherein said heat contacting layer, said bottom casing layer, and said heat transfer member's upper and bottom walls are made of metal.

7. A stovetop cookware comprising:
a heat contacting layer made of metal having a bottom surface for contacting a heat source, an upper interior surface, and a periphery;
an upper cooking layer made of metal having an upper surface for cooking food, a lower interior surface, and a periphery;
said heat contacting layer's periphery engaging said upper cooking layer's periphery with said heat contacting layer's upper surface spaced apart from said upper cooking layer's lower surface to form a central cavity; and
a heat transfer member within said cavity, said heat transfer member having upper and bottom walls made of metal forming a housing with a ring shaped interior chamber, said heat transfer member further having a granular stone dispersed throughout said ring shaped chamber.

8. The stovetop cookware of claim 7 further comprising an air ventilating hole formed through heat contacting layer or said upper cooking layer to allow air to pass from within said cavity to the exterior environment.

9. The stovetop cookware of claim 7 wherein said granular stone is jade.

10. The stovetop cookware of claim 7 wherein said granular stone emitted infrared rays when heated.
